(19) United States
(12) Patent Application Publication
(10) Pub. No.: US 2022/0094272 A1
(43) Pub. Date: Mar. 24, 2022

(54) DESIGN AND OPTIMIZATION OF A HIGH POWER DENSITY LOW VOLTAGE DC-DC CONVERTER FOR ELECTRIC VEHICLES

(71) Applicants: Wenbo LIU, Kingston (CA); Yang CHEN, Kingston (CA); Xiang ZHOU, Kingston (CA); Andrew YUREK, Kingston (CA); Mojtaba FOROUZESH, Kingston (CA); Bo SHENG, Kingston (CA); Sam WEBB, Kingston (CA); Yan-fei LIU, Kingston (CA); Lakshmi Varaha IYER, Troy, MI (US); Gerd SCHLAGER, Kefermarkt (AT); Michael NEUDORFHOFER, Sankt Valentin (AT); Wolfgang BAECK, Sankt Valentin (AT); MAGNA INTERNATIONAL INC., Aurora (CA)

(72) Inventors: Wenbo LIU, Kingston (CA); Yang CHEN, Kingston (CA); Xiang ZHOU, Kingston (CA); Andrew YUREK, Kingston (CA); Mojtaba FOROUZESH, Kingston (CA); Bo SHENG, Kingston (CA); Sam WEBB, Kingston (CA); Yan-Fei LIU, Kingston (CA); Lakshmi Varaha IYER, Troy, MI (US); Gerd SCHLAGER, Kefermarkt (AT); Michael NEUDORFHOFER, Sankt Valentin (AT); Wolfgang BAECK, Sankt Valentin (AT)

(21) Appl. No.: 17/425,656

(22) PCT Filed: Jan. 24, 2020
(86) PCT No.: PCT/US2020/015065

§ 371 Date: Jul. 23, 2021

Related U.S. Application Data
(60) Provisional application No. 62/796,828, filed on Jan. 25, 2019.

(51) Int. Cl. H02M 3/335; H01F 27/28; H01F 27/40; H01F 30/10; H02M 7/48

(52) U.S. Cl. CPC H02M 3/33569; H01F 27/2847; H02M 7/4815; H01F 30/10; H01F 27/40

(57) ABSTRACT

An inductor-inductor-capacitor (EEC) power converter with high efficiency for Electric Vehicle (EV) on-board low voltage DC-DC chargers (LDC) is disclosed. The converter includes a switching bridge with a plurality of bridge switches and configured to generate an output from a direct current input voltage. An EEC tank circuit is coupled to the switching bridge and includes a resonant inductor and a resonant capacitor and a parallel inductor connected between the resonant inductor and the resonant capacitor. The tank circuit is configured to output a resonant sinusoidal current from the output of the switching bridge. At least one transformer has at least one primary winding in parallel with the parallel inductor of the inductor-inductor-capacitor tank circuit and at least one secondary winding. At least one rectifier is coupled to the at least one secondary winding and is configured to output a rectified alternating current.

### CROSS REFERENCE TO RELATED APPLICATION

This PCT International Patent application claims the benefit of U.S. Provisional Application No. 62/796,828 filed Jan. 25, 2019 entitled “Design and Optimization of a High Power Density Low Voltage DC-DC Converter for Electric Vehicles (EVs). The entire disclosure of the application being considered part of the disclosure of this application and hereby incorporated by reference.

### FIELD

The present disclosure relates generally to DC-DC converters. More specifically, the present disclosure relates to an inductor-inductor-capacitor (LLC) type DC-DC power converter.

### BACKGROUND

With an increasing demand of environmentally friendly energy, the research and development of electric vehicles (EVs) technologies are becoming more significant. For an EV power system, a low voltage DC-DC converter (LDC) is needed to convert the power from high voltage battery (250V to 430V) to low voltage battery (9V to 16V) to support the lighting, audio, air conditioner and other auxiliary functions. Such functions make users more comfortable, but in contrast, they also requires the LDC to provide higher power. High power and low voltage together introduce the problem of extremely high output current, which is a great obstacle for improving the efficiency and size.

In addition, the developing EV battery technology and market still seek solutions that are safer, smaller and more efficient. A need therefore exists for an improved converters. Accordingly, a solution that addresses, at least in part, the above-noted shortcomings and advances the art is desired.

### SUMMARY

This section provides a general summary of the present disclosure and is not intended to be interpreted as a comprehensive disclosure of its full scope or all of its features, aspects and objectives.

It is an aspect of the present disclosure to provide a direct current-direct current (DC-DC) converter. The converter includes a switching bridge having a plurality of bridge switches. The switching bridge is configured to generate a square waveform output from a direct current input voltage provided across a positive input terminal and a negative input terminal. An inductor-inductor-capacitor tank circuit is coupled to the switching bridge and includes a resonant inductor, a resonant capacitor, and a parallel inductor connected between the resonant inductor and the resonant capacitor. The inductor-inductor-capacitor tank circuit is configured to output a resonant sinusoidal current from the square waveform output of the switching bridge. The converter also includes at least one transformer having at least one primary winding in parallel with the parallel inductor of the inductor-inductor-capacitor tank circuit and at least one secondary winding. At least one rectifier is coupled to the at least one secondary winding of the at least one transformer and configured to output a rectified alternating current across a positive output terminal and a negative output terminal.

These and other aspects and areas of applicability will become apparent from the description provided herein. The description and specific examples in this summary are intended for purpose of illustration only and are not intended to limit the scope of the present disclosure.

### DRAWINGS

The drawings described herein are for illustrative purposes only of selected embodiments and not all implementations, and are not intended to limit the present disclosure to only that actually shown. With this in mind, various features and advantages of example embodiments of the present disclosure will become apparent from the following written description when considered in combination with the appended drawings, in which:

FIG. 1 is a block diagram schematic diagram showing a power distribution system of a motor vehicle including a low-voltage DC-DC converter (LDC) according to aspects of the disclosure;

FIG. 2 is a circuit diagram of an example single phase two-transformer inductor-inductor-capacitor (LLC) LDC according to aspects of the disclosure;

FIG. 3 shows a cross-sectional view of the two transformers of the converter according to aspects of the disclosure;

FIG. 4 shows a graph of voltage gain vs. nominated frequency according to aspects of the disclosure;

FIG. 5 is a diagram showing a magnetic field including fringing effects in a parallel inductor with a traditional winding;

FIGS. 6-8 show steps of assembling a parallel inductor of the converter with a separated winding according to aspects of the disclosure;

FIG. 9 is a diagram showing a magnetic field including fringing effects of the parallel inductor with the separated winding according to aspects of the disclosure; and

FIG. 10 is a graph showing efficiencies of the converter at 14V output and with different input voltages according to aspects of the disclosure.

### DETAILED DESCRIPTION

In the following description, details are set forth to provide an understanding of the present disclosure. In some instances, certain circuits, structures and techniques have not been described or shown in detail in order not to obscure the disclosure.

In general, a low voltage DC-DC converter (LDC) is disclosed herein. The converter of this disclosure will be described in conjunction with one or more example embodiments. More specifically, a low voltage DC-DC converter having high power density is disclosed. In some embodiments, the DC-DC converter may be used as an onboard battery charger for electric vehicles (EVs). However, the specific example embodiments disclosed are merely provided to describe the inventive concepts, features, advantages and objectives will sufficient clarity to permit those skilled in this art to understand and practice the disclosure.

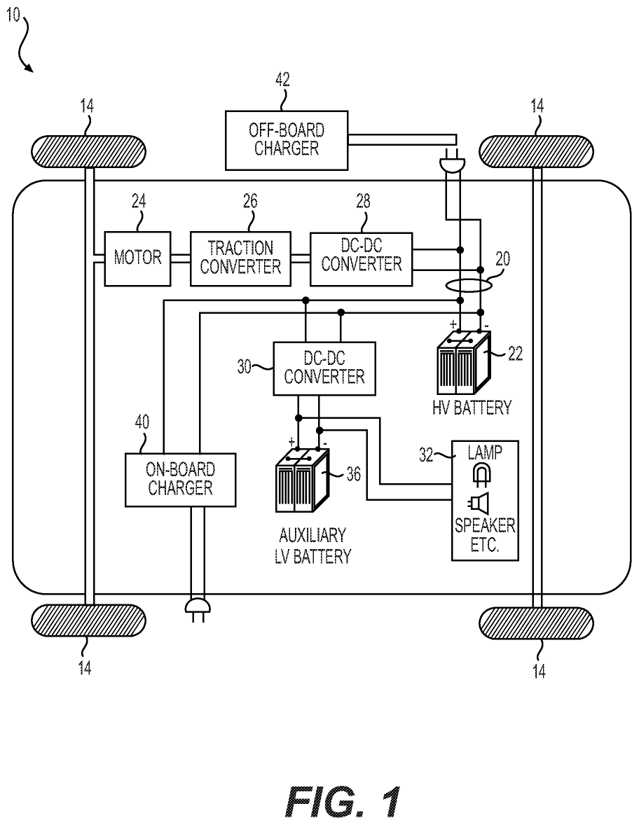

Recurring features are marked with identical reference numerals in the figures. FIG. 1 is a schematic diagram showing a power distribution system 10 of a motor vehicle 12 having a plurality of wheels 14. The power distribution system 10 includes a high-voltage (HV) bus 20 connected to a HV battery 22 for supplying power to a motor 24, which is configured to drive one or more of the wheels 14. The HV bus 20 may have a nominal voltage that is 250 VDC-430 VDC, although other voltages may be used. The motor 24 is supplied with power via a traction converter 26, such as a variable-frequency alternating current (AC) drive, and a high-voltage DC-DC converter 28. The high-voltage DC-DC converter 28 supplies the traction converter 26 with filtered and/or regulated DC power having a voltage that may be greater than, less than, or equal to the DC voltage of the HV bus 20. A low-voltage DC-DC converter (LDC) 30 is connected to the HV bus 20 and is configured to supply low-voltage (LV) power to one or more LV loads 32 via a LV bus 34. The LDC 30 may be rated for 1-3 kW, although the power rating may be higher or lower. The LV loads 32 may include, for example, lighting devices, audio devices, etc. The LDC 30 may be configured to supply the low-voltage loads 32 with DC power having a voltage of, for example, 9-16 VDC, although other voltages may be used. An auxiliary LV battery 36 is connected to the LV bus 34. The auxiliary LV battery 36 may be a lead-acid battery, such as those used in conventional vehicle power systems. The auxiliary LV battery 36 may supply the LV loads 32 with power when the LDC 30 is unavailable. Alternatively or additionally, the auxiliary LV battery 36 may provide supplemental power to the LV loads 32 in excess of the output of the LDC 30. For example, the auxiliary LV battery 36 may supply a large inrush current to a starter motor that exceeds the output of the LDC 30. The auxiliary LV battery 36 may stabilize and/or regulate the voltage on the LV bus 34. An onboard charger 40 and/or an off-board charger 42 supply HV power to the HV bus 20 for charging the HV battery 22.

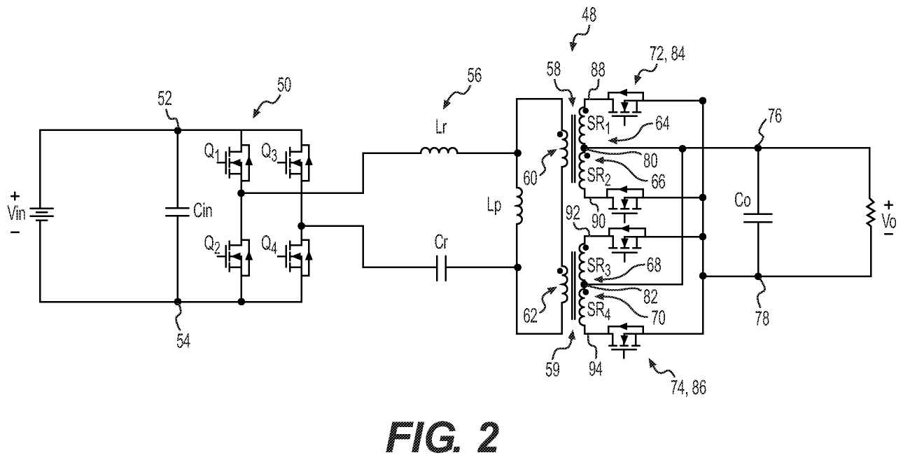

FIG. 2 shows a circuit diagram of a single phase converter 48 (e.g., as part of or comprising LDC 30). The converter 48 includes a switching bridge 50 with a plurality of bridge switches Q1, Q2, Q3, Q4 and configured to generate a square waveform output from a direct current input voltage Vin provided across a positive input terminal 52 and a negative input terminal 54. An inductor-inductor-capacitor tank circuit 56 is coupled to the switching bridge 50 and includes a resonant inductor Lr, a resonant capacitor Cr, and a parallel inductor Lp connected between the resonant inductor Lr and the resonant capacitor Cr. The inductor-inductor-capacitor tank circuit 56 is configured to output a resonant sinusoidal current from the square waveform output of the switching bridge 50. The converter 48 also includes at least one transformer 58, 59 having at least one primary winding 60, 62 in parallel with the parallel inductor Lp of the inductor-inductor-capacitor tank circuit 56 and at least one secondary winding 64, 66, 68, 70. In addition, at least one rectifier 72, 74 is coupled to the at least one secondary winding 64, 66, 68, 70 of the at least one transformer 58, 59 and configured to output a rectified alternating current Vo across a positive output terminal 76 and a negative output terminal 78. It should be appreciated that while only a single phase is shown, the converter 48 may comprise multiple single phase circuits for each phase (e.g., 3 phase).

According to an aspect, the at least one transformer 58, 59 includes a first transformer 58 and a second transformer 59 in parallel to share a load current conducted across the positive output terminal 76 and the negative output terminal 78 and reduce a secondary power loss. In other words, the two transformers 58, 59 are connected in parallel on the secondary side to decrease the high output current stress and connected in series on primary side to balance the load.

Specifically, the least one primary winding 60, 62 includes a first primary winding 60 and a second primary winding 62 (the first and second primary winding 60, 62 are shown separately in FIG. 2, however, could instead be a single primary winding). The at least one secondary winding 64, 66, 68, 70 includes a pair of first secondary windings 64, 66 with a first center tap terminal 80 disposed therebetween and a pair of second secondary windings 68, 70 with a second center tap terminal 82 disposed therebetween. Thus, the first transformer 58 comprises the first primary winding 60 and the pair of first secondary windings 64, 66 and the second transformer 59 comprises the second primary winding 62 and the pair of second secondary windings 68, 70.

The at least one rectifier 72, 74 includes a first synchronous rectifier 84 coupled to the pair of first secondary windings 64, 66 and a second synchronous rectifier 86 coupled to the pair of second secondary windings 68, 70. The first synchronous rectifier 84 includes a first synchronous rectification switch SR1 coupled between a first positive secondary terminal 88 of the pair of first secondary windings 64, 66 and the negative output terminal 78. The first synchronous rectifier 84 also includes a second synchronous rectification switch SR2 coupled between a first negative secondary terminal 90 of the pair of first secondary windings 64, 66 and the negative output terminal 78. The second synchronous rectifier 86 includes a third synchronous rectification switch SR3 coupled between a second positive secondary terminal 92 of the pair of second secondary windings 68, 70 and the negative output terminal 78. The second synchronous rectifier 86 additionally includes a fourth synchronous rectification switch SR4 coupled between a second negative secondary terminal 94 of the pair of second secondary windings 68, 70 and the negative output terminal 78. The first center tap terminal 80 and second center tap terminal 82 are connected together and to the positive output terminal 76. The converter 48 further includes an input capacitor Cin connected across the positive output terminal 76 and negative output terminal 78 for filtering the rectified alternating current. An input capacitor Cin is connected across the positive input terminal 52 and the negative input terminal 54. According to an aspect, the first synchronous rectification switch SR1 and the second synchronous rectification switch SR2 and the third synchronous rectification switch SR3 and the fourth synchronous rectification switch SR4 all comprise gallium nitride (GaN) high-electron-mobility transistors. Nevertheless, other types of switches are contemplated.

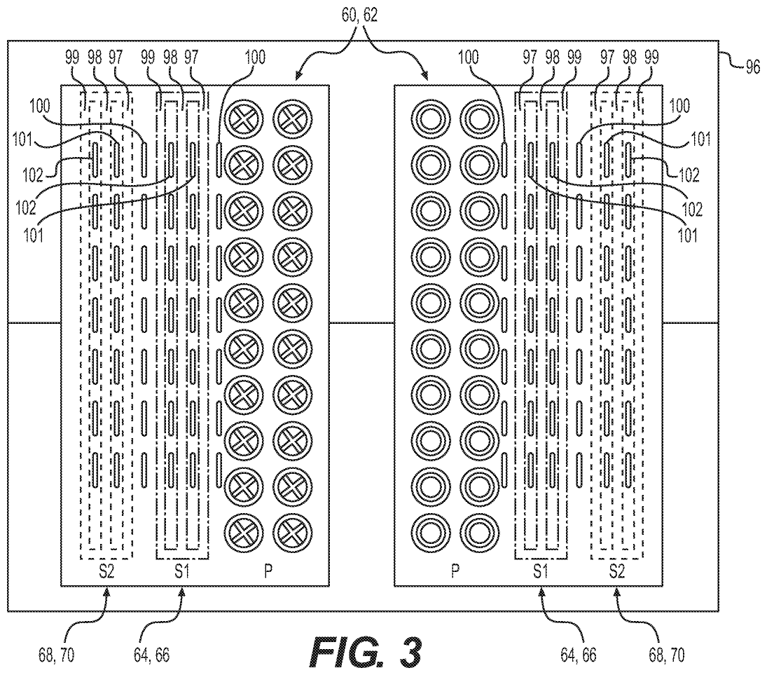

As best shown in FIG. 3, the primary winding P (the first primary winding 60 and the second primary winding 62) is wrapped around a transformer core 96 (e.g., Ferroxcube® PQ35/35 core of 3C97 material) the at least one secondary winding 64, 66, 68, 70 includes the first secondary windings 64, 66 at the second secondary windings 68, 70 (shown as S1 and S2). The first secondary windings 64, 66 at the second secondary windings 68, 70 each include a laminated metallic strip having a plurality of secondary conductor layers 97, 98, 99 alternating with a plurality of secondary insulating layers 100, 101, 102 (e.g., isolation tape) to decrease an alternating current skin effect, discussed in more detail below.

Proper design of the magnetic components is important to maximize the power capacity within limited component size. To implement the wide input/output voltage range and guarantee the LLC converter 48 has zero volt switching (ZVS) on primary side while zero current switching (ZCS) on secondary side, the resonant point (Voltage gain is 1) is selected to be the maximum input voltage and minimum output voltage condition. The turns ratio of the transformer 58, 59 is determined by formula (1): n=Nₚ:Nₛ=Vᵢₙ₋ₘₐₓv_{o_min}, where Nₚ is the primary side number of turns and Ns is the secondary winding turns number. With 250V to 430V input and 9V to 16V output voltage range, the transformer turns ratio is selected to be 22:1:1 (consider the two primary windings 60, 62 in series and center-taped structure). Thus, the primary winding 60, 62 is formed using 22 turns of 2 layers of litz wire 1050 strands each with a 1.83 mm outer diameter (e.g., 5×5/42/46).

In order to increase the power density, the switching frequency of the converter 48 is designed to be 250 kHz to 400 kHz, thus the resonant inductor Lr is 25 uH and the resonant capacitor Cr is 3.4 nF in this configuration.

The selection of Lp is a tradeoff between the voltage gain (current capacity) and efficiency. In general, a major barrier of high current LLC converters is that Lp value should be controlled to be small to fulfill high voltage gain requirement. High circulation current will be induced when the Lp value is low and this high current can increase the conduction loss on primary side. However, with the high switching frequency design, the magnetizing current can be well mitigated, and the high load current and high secondary conduction loss still dominate the total loss. A small inductance value of Lₚ which will not significantly affect the overall efficiency is chosen to cover the full range of gain requirement with some margin.

The voltage gain of the proposed converter 48 based on fundament harmonic analysis (FHA) is given by formula (2):

$$M = \frac{2 {nV}_{o}}{{V}_{in}} = \frac{K}{\sqrt{{[ {( \frac{{ω}_{r}}{{ω}_{s}} )}^{2} - K - 1 ]}^{2} + {\frac{{( {π}^{2} {ω}_{s} {L}_{p} )}^{2}}{64 {n}^{4} {R}_{L}^{2}} [ {( \frac{{ω}_{r}}{{ω}_{s}} )}^{2} - 1 ]}^{2}}} . , \\ where K = \frac{{L}_{p}}{{L}_{r}} , {ω}_{s} = 2 π {f}_{s} , and {ω}_{r} = \frac{1}{\sqrt{{L}_{r} {C}_{, eq}}} .$$

The peak voltage gain is required when the converter 48 is in highest output voltage and lowest input voltage condition, which is calculated by formula (3):

$${G}_{max} = \frac{{V}_{in \_ max}}{{V}_{o \_ max}} * \frac{{N}_{s}}{2 {N}_{p}}$$

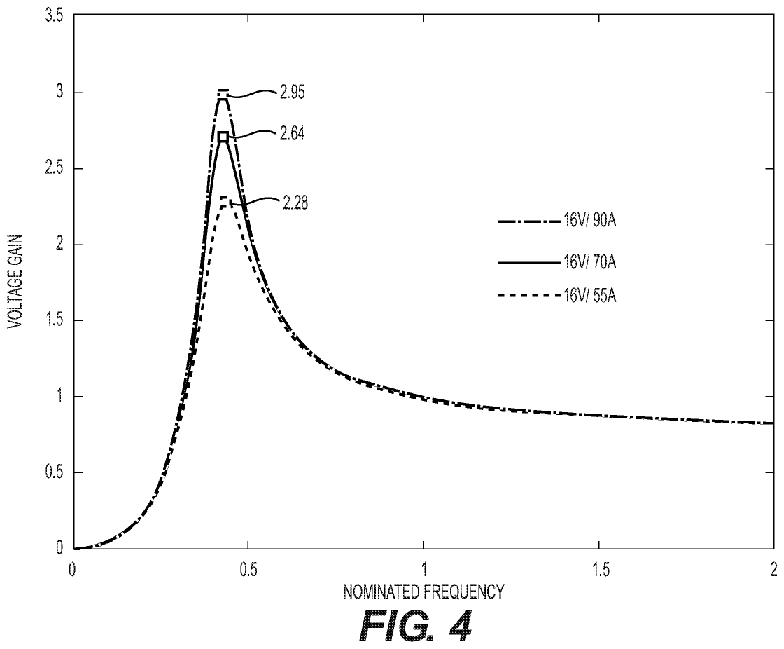

In the present disclosure, load capacity is different for different input conditions. For 250V to 320V input voltage, 60% load current is needed; for 320V to 430V, the converter is rated for full power. To fulfill the maximum gain requirement of 2.8 at half load and 2.2 at full load, Lp is designed to be 125 uH. FIG. 4 shows the gain curves of the converter 48 which meet this range. The specificaitons and parameters of resoant components are shown in Table 1.

TABLE 1
Specifications of the Proposed LLC LDC

| Maximum | Input | Output | Switching | Lr | Lp | Cr | Transformer |
|---|---|---|---|---|---|---|---|
| Power | Voltage | Voltage | Frequency | Inductance | Inductance | Capacitance | Turns Ratio |
| 1.3 kW | 250 V~430 V | 9 V~16 V | 250 kHz~500 kHz | 25 uH | 125 uH | 3.4 nF | 22:1:1 |

Magnetic components are important design targets in the converter 48 to achieve promising efficiency. A loss analysis algorithm was built to estimate the total losses of Lr, Lp and transformer based on calculation of winding loss and core loss. The Litz wire size, number of turns and copper foil thickness are selected efficiency wisely for each magnetic component.

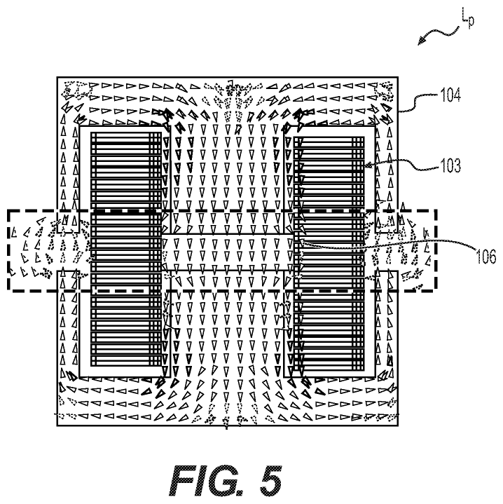

In order to maintain the full input and output voltage range, the Lp inductance value is selected to be relatively small. However, to minimize the submission of copper loss and core loss, a big number of turns is selected. Thus, to meet the inductance value, a 5 mm air gap is required in the actual inductor Lp. However, the flux will not insert into the inductor core in straight lines but enters far into the surrounded winding area around a large air gap. The fringing flux induces voltage drop crosses the coil and causes the eddy current loss. The fringing effect is especially critical if the air gap is large, the power is determined according to formula (4):

$$P = \frac{1}{6 ρ} {( {πμ}_{0} Hf )}^{2} {w}^{3} t ,$$

where μ₀ is the permeability of the free space, ρ is the resistivity of conductor, H is fringing flux, f is the frequency, w is the width of the conductor, t is the thickness of the conductor. An ANSYS finite element analysis (FEA) model was built to simulate the eddy current loss around a large air gap. FIG. 5 illustrates the magnetic field of the parallel inductor Lp with a single coil 103 wound around the inductor core 104. Specifically, several flux lines 106 cut through the single coil 103 and loss is generated in the affected area.

Consequently, a two-coil winding 108, 110 is used instead of one coil 103 in the parallel inductor Lp, so that the copper wires are moved away from the air gap 112. So, the parallel inductor Lp comprises a first inductor coil 108 and a second inductor coil 110 connected in series and each disposed about the inductor core 104 defining the air gap 112. The first inductor coil 108 and second inductor coil 110 each are formed of a copper wire separately wound around the inductor core 104 and spaced from one another by the air gap 112 for reducing an air gap fringing flux. As mentioned above, the air gap 112 is 5 millimeters; however, it should be understood that other smaller or larger air gaps 112 may be used instead.

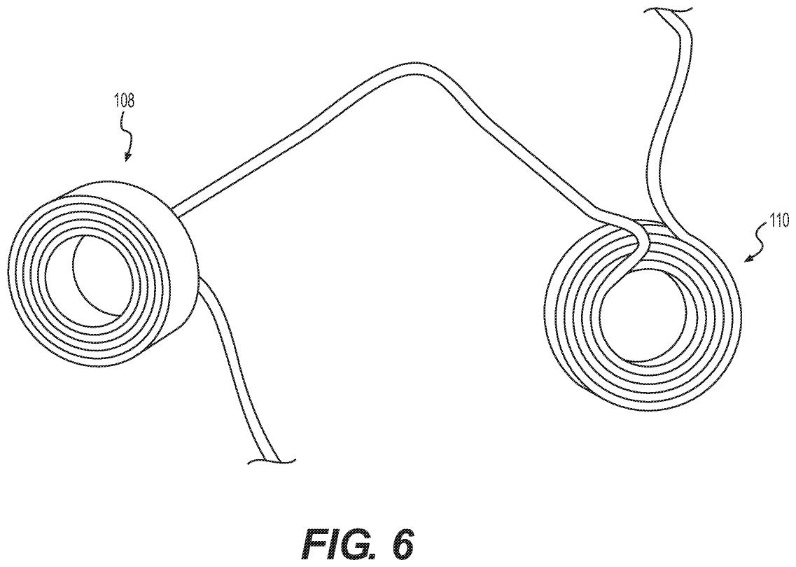

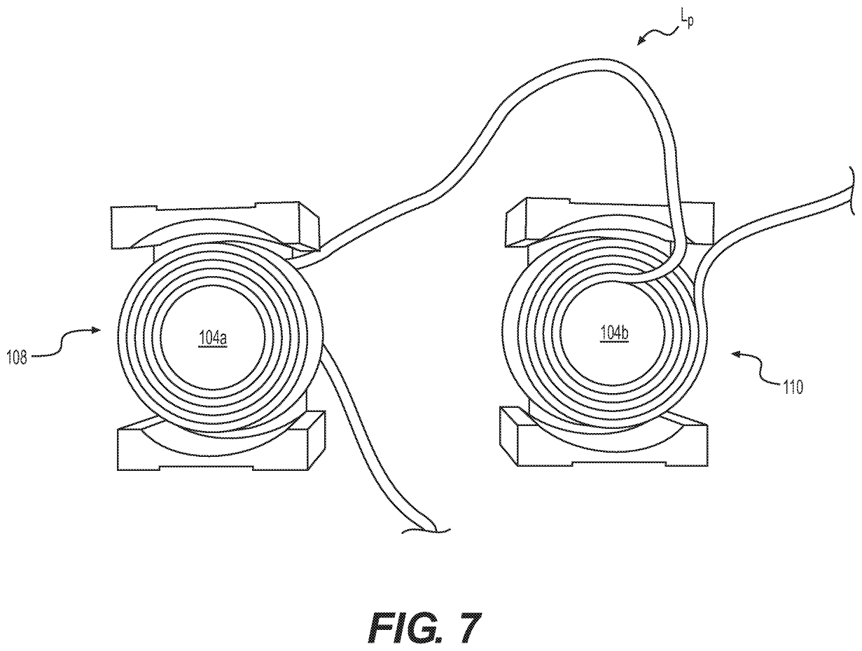

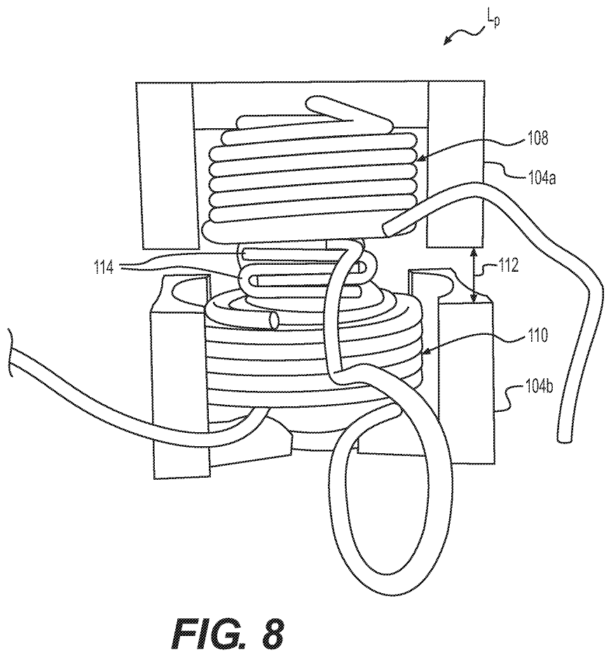

In detail, the parallel inductor Lp is made using the following process. First, making two coils (i.e., the first inductor coil 108 and the second inductor coil 110) with 20 turns of 4 layers for each coil 108, 110. These two coils 108, 110 are built in same direction, as shown in FIG. 6. Next, inserting the first inductor coil 108 and the second inductor coil 110 into separate halves 104a, 104b of the inductor core 104 (e.g., Ferroxcube® PQ35/35 core of 3C97 material), as shown in FIG. 7. The process continues with the step of adjusting the air gap 112 to 5 mm by adding papers 114 onto the halves 104a, 104b the core 104, as shown in FIG. 8.

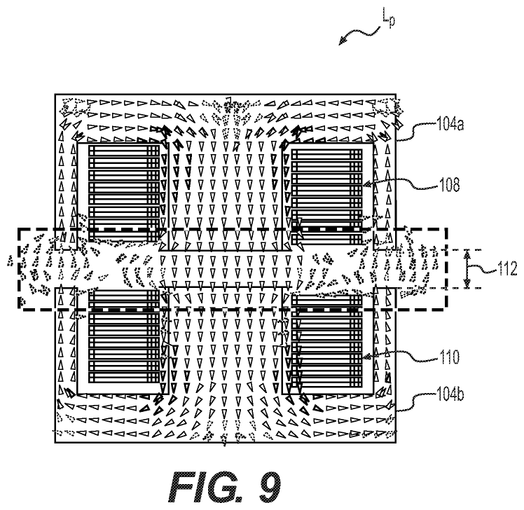

As best shown in FIG. 9, the area affected by the fringing flux is significantly reduced compared with that in FIG. 5. According to equation (4), the winding and total flux are decreased, so the eddy current loss is decreased.

One other considerable loss factor of the magnetic components is that the high current stress transformer secondary winding 64, 66, 68, 70. In order to avoid the conduction loss, a thick copper foil is required to guarantee the resistance to be enough low. However, with the high operating frequency of converter 48, the skin depth δ is very thin and it introduce high AC resistance into the winding. Deriving from formula (5):

$$δ = \sqrt{\frac{ρ}{π f {μ}_{r} {μ}_{0}}} ,$$

the skin depth δ is 0.12 mm at 300 kHz frequency.

Therefore, referring back to FIG. 3, a three-layer laminated 0.25 mm copper foil 116 is used for each of the secondary windings S1 and S2 (shown as 64, 66, 68, 70 in FIG. 2) instead of a 0.75 mm single layer thick copper foil. The plurality of secondary conductor layers 97, 98, 99 that alternate with the plurality of secondary insulating layers 100, 101, 102 includes three secondary conductor layers 97, 98, 99 formed of copper that alternate with three corresponding secondary insulating layers 100, 101, 102. The three secondary conductor layers 97, 98, 99 are each 0.25 millimeters thick. However, it should be understood that other embodiments may use more or fewer layers of different thicknesses. Based on the above parameters, the performances of proposed converter 48 are estimated. Table 2 shows the comparison between the existing LDC and converter 48.

TABLE 2
Comparison between Proposed and Conventional LDC designs

| | Specification of the converter | | | | | | |
|---|---|---|---|---|---|---|---|
| | Input | Output | | Peak | Full-load | Power | Switching |
| Converter | voltage | voltage | power | efficiency | efficiency | density | frequency |
| [1] | 200 V~400 V | 12 V | 1.2 kW | 95.5% | 90% | 0.5 kW/L | 100 kHz |
| [2] | 235 V~431 V | 11.5 V~15 V | 2 kW | 93.5% | 93% | 0.94 kW/L | 200 kHz |
| [3] | 300 V~400 V | 12 V~16 V | 0.72 kW | 93.5% | 90% | — | 100 kHz |
| [4] | 220 V~450 V | 6.5 V~16 V | 2.5 kW | 93.2% | 92% | 1.17 kW/L | 90 kHz~200 kHz |
| [5] | 200 V~400 V | 12 V | 2 kW | 95.9% | 94.2% | — | 100 kHz~133 kHz |
| Proposed LDC | 250 V~430 V | 9 V~16 V | 1.3 kW | 97% | >96% | 3.12 kW/L | 260 kHz~400 kHz |

So, as shown in table 2, the DC-DC converter disclosed herein improves upon other converters and is configured to have a peak efficiency of 97% with an input voltage supplied across the positive input terminal and negative input terminal between 250 Volts and 430 Volts and supplying an output voltage across the positive output voltage terminal and the negative output terminal between 9 Volts and 16 Volts with a switching frequency between 260 kilohertz and 400 kilohertz.

A single phase full-bridge inductor-inductor-capacitor (LLC) power converter 48 with 90 A maximum load current and 1.3 kW rated full power prototype was built to verify the performance of the converter 48. In more detail, the LLC converter 48 was assembled on a two layer printed circuit board (PCB) with a dimension of 190 mm*45 mm, the total height is 49 mm. The magnetics were fabricated as designed: Lr is 25.6 uH, Lp is 126.2 uH and Cr is 3.4 nF (680 pF*5). A water cooling system was also be used to provide improved thermal performances, especially for the secondary side synchronous rectifiers (SR1, SR2, SR3, SR4) with high current stress.

The impact of modified magnetics are verified during the test. The loss of parallel inductor is decreased by 3 W by changing one coil winding into two separate windings 108, 110 and leaving no coil 180, 110 around the air gap 112. The light load efficiency is significantly improved consequently. The thermal performance of Lp with conventional winding structure was verified using FLIR imaging and indicates that the coils 108, 110 (e.g., copper wires) around the air gap 112 is much hotter than the surrounding areas, which corresponds with the fringing effect of large air gap 112. In contrast, the winding temperature of Lp with separate winding coils 108, 110 was also verified using FLIR imaging under the same operating conditions and the hot spot around air gap remedied and the coil is 30° C. cooler than the conventional configuration. The temperatures of the laminated three layer transformer secondary windings 64, 66, 68, 70 (S1 and S2 in FIG. 3) are also lower than the one-layer thick copper foil transformers. The loss is reduced by 2 W and temperature rise is reduced by 20° C. at full load condition.

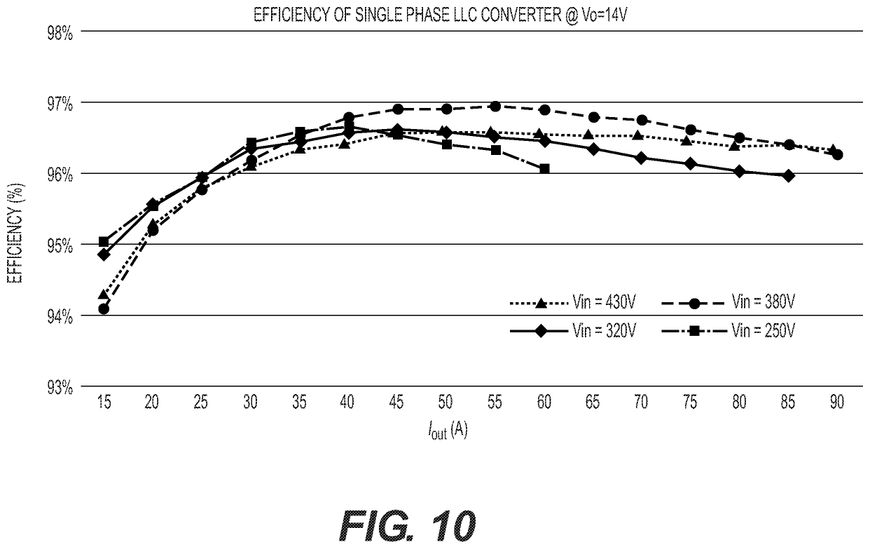

The full input and output voltage range were tested on the prototype of the single-phase converter 48. FIG. 10 shows the efficiency at 14V (target LV battery voltage) output and different input conditions. The peak efficiency of the LDC converter 48 is 97% at 55 A load current with 380V-14V condition and the full load efficiency is all the way higher than 96% for all the cases.

This disclosure presents the design and optimization methodology of a single phase LLC converter 48 for LDC on EVs. 3.12 kW/L high power density and more than 96% full load efficiency has been achieved. Thus, the converter 48 described herein provides improved power density over known converters. The proposed converter 48 makes use of GaN HEMT and high switching frequency to significantly improve the power density. Two transformers 58, 59 are paralleled to carrier the high load current and reduce the secondary I²R loss. The parameters of resonant components Cr, Lr and Lp are designed to cover the full input voltage range of 250V to 430V and output voltage from 9V to 16V are covered without sacrificing efficiency. The large air gap fringing effect on Lp is mitigated by separating the coil winding into two coils 108, 110 and AC skin effect of the transformers 58, 59 is decreased by using three layer of laminated copper foils 97, 98, 99. Overall efficiency is further improved benefiting from this structure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Those skilled in the art will recognize that concepts disclosed in association with the converter 48 disclosed can likewise be implemented into many other systems to control one or more operations and/or functions.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

1. A DC-DC converter comprising:
a switching bridge including a plurality of bridge switches and configured to generate a square waveform output from a direct current input voltage provided across a positive input terminal and a negative input terminal;
an inductor-inductor-capacitor tank circuit coupled to the switching bridge and including a resonant inductor and a resonant capacitor and a parallel inductor connected between the resonant inductor and the resonant capacitor and configured to output a resonant sinusoidal current from the square waveform output of the switching bridge;
at least one transformer having at least one primary winding in parallel with the parallel inductor of the inductor-inductor-capacitor tank circuit and at least one secondary winding; and
at least one rectifier coupled to the at least one secondary winding of the at least one transformer and configured to output a rectified alternating current across a positive output terminal and a negative output terminal.

2. The DC-DC converter as set forth in claim 1, wherein the at least one secondary winding includes a laminated metallic strip having a plurality of secondary conductor layers alternating with a plurality of secondary insulating layers to decrease an alternating current skin effect.

3. The DC-DC converter as set forth in claim 2, wherein the plurality of secondary conductor layers includes three secondary conductor layers formed of copper.

4. The DC-DC converter as set forth in claim 3, wherein the three of secondary conductor layers are each 0.25 millimeters thick.

5. The DC-DC converter as set forth in claim 1, wherein the parallel inductor comprises a first inductor coil and a second inductor coil each disposed about an inductor core defining an air gap.

6. The DC-DC converter as set forth in claim 5, wherein the first inductor coil and second inductor coil each are formed of a copper wire separately wound around the inductor core and spaced from one another by the air gap for reducing an air gap fringing flux.

7. The DC-DC converter as set forth in claim 5, wherein the air gap is 5 millimeters.

8. The DC-DC converter as set forth in claim 1, wherein the at least one transformer includes a first transformer and a second transformer in parallel to share a load current conducted across the positive output terminal and the negative output terminal and reduce a secondary power loss.

9. The DC-DC converter as set forth in claim 8, wherein the at least one primary winding includes a first primary winding and a second primary winding and the at least one secondary winding includes a pair of first secondary windings with a first center tap terminal disposed therebetween and a pair of second secondary windings with a second center tap terminal disposed therebetween, the first transformer comprising the first primary winding and the pair of first secondary windings and the second transformer comprising the second primary winding and the pair of second secondary windings.

10. The DC-DC converter as set forth in claim 9, wherein the at least one rectifier includes a first synchronous rectifier coupled to the pair of first secondary windings and a second synchronous rectifier coupled to the pair of second secondary windings, the first synchronous rectifier including a first synchronous rectification switch coupled between a first positive secondary terminal of the pair of first secondary windings and the negative output terminal and a second synchronous rectification switch coupled between a first negative secondary terminal of the pair of first secondary windings and the negative output terminal, the second synchronous rectifier including a third synchronous rectification switch coupled between a second positive secondary terminal of the pair of second secondary windings and the negative output terminal and a fourth synchronous rectification switch coupled between a second negative secondary terminal of the pair of second secondary windings and the negative output terminal.

11. The DC-DC converter as set forth in claim 10, wherein the first synchronous rectification switch and the second synchronous rectification switch and the third synchronous rectification switch and the fourth synchronous rectification switch all comprise gallium nitride high-electron-mobility transistors.

12. The DC-DC converter as set forth in claim 9, wherein the first center tap terminal and the second center tap terminal are connected together and to the positive output terminal, the DC-DC converter further including an input capacitor connected across the positive output terminal and negative output terminal for filtering the rectified alternating current.

13. The DC-DC converter as set forth in claim 1, further including an input capacitor connected across the positive input terminal and the negative input terminal.

14. The DC-DC converter as set forth in claim 1, wherein the resonant inductor has an inductance between 25 and 26 microhenries and the resonant capacitor has a capacitance between 3 and 4 nanofarads and the parallel inductor has an inductance between 126 and 127 microhenries.

15. The DC-DC converter as set forth in claim 1, wherein the DC-DC converter is configured to have a peak efficiency of 97% with an input voltage supplied across the positive input terminal and negative input terminal between 250 Volts and 430 Volts and supplying an output voltage across the positive output terminal and the negative output terminal between 9 Volts and 16 Volts with a switching frequency between 260 kilohertz and 400 kilohertz.

16. A DC-DC converter comprising:
a switching bridge including a plurality of bridge switches and configured to generate a waveform output from a direct current input voltage provided across a positive input terminal and a negative input terminal;
an inductor-inductor-capacitor tank circuit coupled to the switching bridge and including a resonant inductor and a resonant capacitor and a parallel inductor connected between the resonant inductor and the resonant capacitor and configured to output a resonant sinusoidal current from the waveform output of the switching bridge;
at least one transformer having at least one primary winding in parallel with the parallel inductor of the inductor-inductor-capacitor tank circuit and at least one secondary winding; and
at least one rectifier coupled to the at least one secondary winding of the at least one transformer and configured to output a rectified alternating current across a positive output terminal and a negative output terminal; and
wherein the parallel inductor includes a two-coil winding having a first inductor coil and a second inductor coil, with the first inductor coil being spaced apart from the second inductor coil and connected in series with the second inductor coil.

17. The DC-DC converter of claim 16, wherein the first inductor coil includes a first inductor core half and a second inductor core half spaced apart from one another by an air gap; and wherein the first inductor coil is disposed about the first inductor core half and the second inductor coil is disposed about the second inductor core half.

18. The DC-DC converter of claim 17, wherein the air gap is 5 millimeters.

19. The DC-DC converter of claim 15, wherein each of the first inductor coil and the second inductor coil have a helical shape extending about a common axis.

20. The DC-DC converter of claim 15, wherein each of the first inductor coil and the second inductor coil have a helical shape with a same winding direction.
